(19) United States
(12) Patent Application Publication
(10) Pub. No.: US 2009/0196054 A1
(43) Pub. Date: Aug. 6, 2009

(54) LIGHT HOUSING

(75) Inventor: Goden CHENG, Sansia Chen (TW)

Correspondence Address: PATENTTM.US, P. O. BOX 82788, PORTLAND, OR, 97282-0788, US

(73) Assignee: TOMORROW ENERGY LIGHT CO., LTD, Sansia Chen (TW)

(21) Appl. No.: 12/023,932

(22) Filed: Jan. 31, 2008

(51) Int. Cl. F21V 29/00

(52) U.S. Cl. 362/373

(57) ABSTRACT

A light housing has a body, a recess and at least one through hole. The body is thermal conductive and has an outer surface. The recess is formed in the outer surface of the body and allows at least one light emitted diode (LED) to be mounted in the recess. The through hole is defined through the body. Because the light housing allows the LED to be mounted in the recess to eliminate heat from LED directly without consuming electric power, the light housing has a reduced size. Furthermore, the through hole of the body can be variant, so the light housing can be produced with desired dissipation efficiency.

### BACKGROUND OF THE INVENTION

1. Field of Invention

The present invention relates to a light housing, and more particularly to a light housing for light emitted diodes (LEDs), which has excellent heat elimination qualities.

2. Description of the Related Art

Light emitted diodes (LEDs) save electricity, generate less heat, have better performance and are much smaller when compared to traditional fluorescent lamps, so the LEDs replace the traditional fluorescent lamps to become light sources in electric devices.

For protecting the LEDs, a light housing is used and allows at least one LED to be coupled with the light housing. When the LEDs are used for a general street light, a street light in a park, a solar-energy street light, a work lamp or the like, a number of LEDs is increased to achieve a desired brightness. Although the LEDs save electricity and generate less heat, a large amount of LEDs generates a lot of heat.

With reference with FIG. 7, a conventional light device has a light housing (30) and at least one LED (50). The light housing (30) comprises an inner chamber (31) and a heat dissipation device. The heat dissipation device is mounted in the inner chamber (31) of the light housing (30) and may be a heat sink (40) with multiple fins (41), a heat pipe, a fan or the like. The LED (50) is mounted in the inner chamber (31) of the light housing (30) and connects to the heat dissipation device. Therefore, the light housing (30) is used to protect the LED (50) from being damaged and the heat dissipation device is used to eliminate heat.

However, the inner chamber (31) of the light housing (30) contains not only the LED (50), but also the heat dissipation device, so the light housing (30) has to be enlarged and a procedure for producing the light device becomes complex to increase cost of the light device.

To overcome the shortcomings, the present invention provides a light housing to mitigate or obviate the aforementioned.

### SUMMARY OF THE INVENTION

The primary objective of the present invention is to provide a light housing for light emitted diode (LED) light, which has excellent heat elimination qualities.

To achieve the objective, the light housing in accordance with the present invention has a body, a recess and at least one through hole. The body is thermal conductive and has an outer surface. The recess is formed in the outer surface of the body and allows at least one light emitted diode (LED) to be mounted in the recess. The through hole is defined through the body. Because the light housing allows the LED to be mounted in the recess to eliminate heat from LED directly without consuming electric power, the light housing has a reduced size. Furthermore, the through hole of the body can be variant, so the light housing can be produced with desired dissipation efficiency.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective operational view of a light housing in accordance with the present invention with an LED;

FIG. 2 is a perspective view of the light housing in FIG. 1 with an LED;

FIG. 3 is an end view of the light housing in FIG. 1;

FIG. 4 is a cross sectional top view of the light housing in FIG. 1;

FIG. 5 is a cross sectional end view of a first variant of a cubicle of a light housing in accordance with the present invention;

FIG. 6 is a cross sectional end view of a second variant of a cubicle of a light housing in accordance with the present invention; and

FIG. 7 is a cross sectional end view of a conventional light housing in accordance with the prior art with an LED and a heat sink.

### DETAILED DESCRIPTION OF THE INVENTION

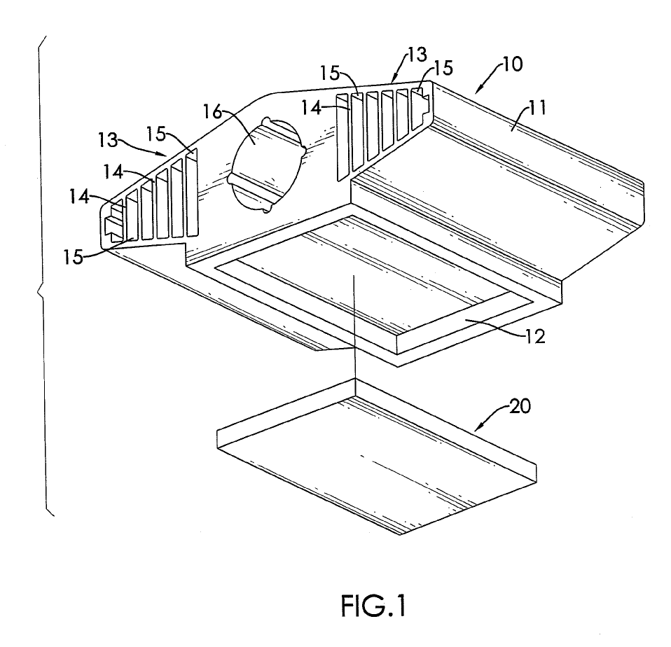

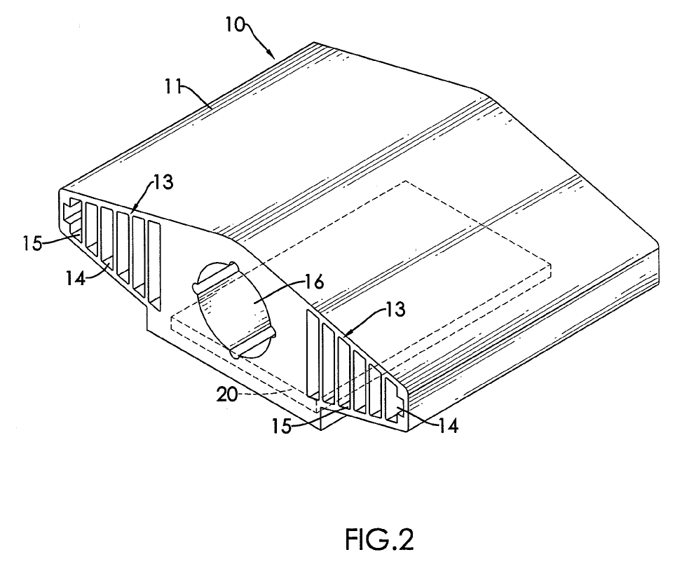

With reference to FIGS. 1 and 2, a light device comprises a light housing (10) in accordance with the present invention and at least one light emitted diode (LED, 20).

The light housing (10) has a body (11), a recess (12), at least one through hole (13) and a fastening hole (16).

The body (11) is thermal conductive (may be made of metal), can be any shape to decorate streets, parks or the like, is able to eliminate heat from the body (11) toward environment and has an outer surface. The outer surface is a heat dissipation area. The body (11) may be hexagonal and has a top, a bottom, two sides and two ends. The top is reversed-V shaped. The bottom is flat.

The recess (12) is formed in the outer surface of the body (11) and may be formed in the bottom of a hexagonal body (11).

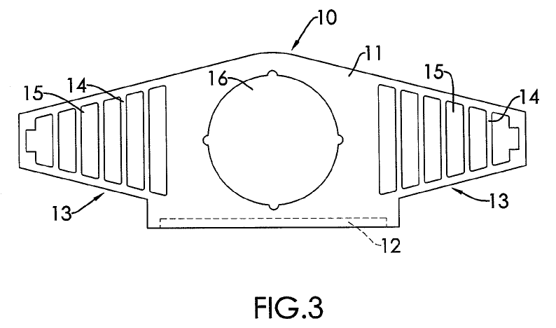

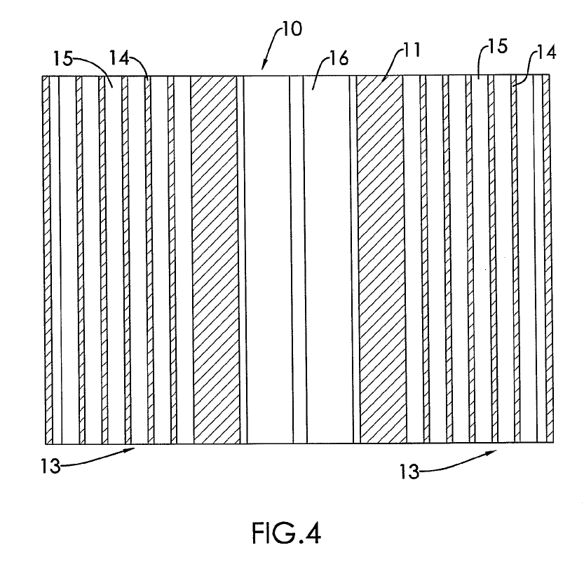

With further reference to FIGS. 3 and 4, the at least one through hole (13) is defined through the body (11) of the light housing (10) and may be define through the hexagonal body (11) from one end to the other end. Each through hole (13) has a cross section, an inner chamber, an inner wall and at least one fin (14). The cross section of the through hole (13), for example, may be but is not limited to be triangular, quadrilateral, circular, oval-shaped, regular or irregular polygonal or the like. The inner wall increases the heat dissipation area. The at least one fin (14) is thermal conductive, is mounted in the inner chamber of a corresponding through hole (13) and connects to the inner wall to separate the inner chamber into multiple cubicles (13). Therefore, the at least one fin (14) further increases the heat dissipation area.

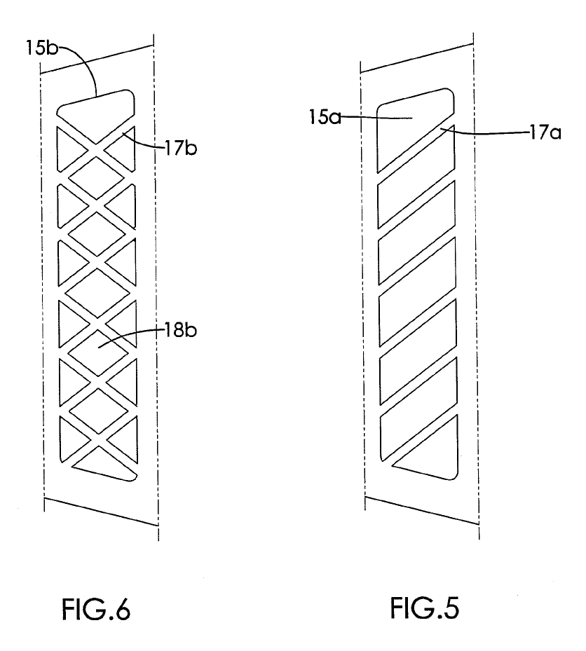

With further reference to FIG. 5, a first variant of the cubicle (15a) may further comprise multiple partitions (17a). The partitions (17a) are mounted in the cubicle (15a) in parallel to increase the heat dissipation area.

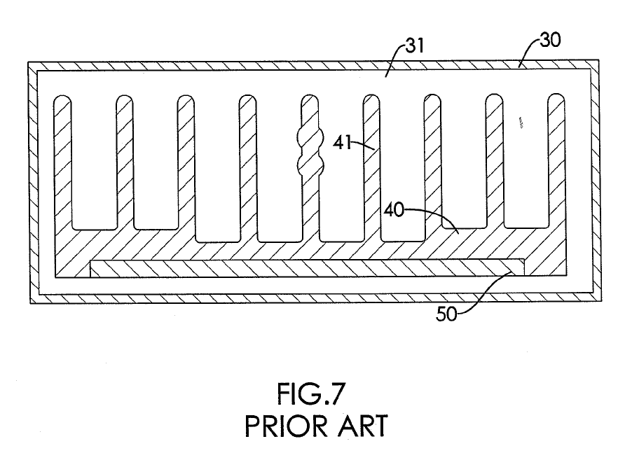

With further reference to FIG. 6, a second variant of the cubicle (15b) may further comprise multiple net partitions (17b). The net partitions (17b) are mounted in the cubicle (15a) to separate the cubicle (15a) into multiple grids (18b) to further increase the heat dissipation area.

The partitions may have variant constructions that can be known by those skilled in the art.

The fastening hole (16) is defined through the body (11) of the light housing (10), may be defined through the hexagonal body (11) from one end to the other end and allows the light housing (10) to be fastened on the light device by a pin or the like.

The at leas one LED (20) is mounted in the recess (12) of the light housing (10) and comprises a circuit board and electrical wire connecting to electric power.

Because the light housing allows the LED (20) to be mounted in the recess (12) to eliminate heat from LED (20) directly without consuming electric power, the light housing (10) has a reduced size. Also, a procedure for producing the light device is simple and a product cost of the light device is reduced. Furthermore, the through holes (13) of the body (11) can be variant, so the light housing (10) can be produced with desired dissipation efficiency.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A light housing comprising:
a body being thermal conductive and having an outer surface;
a recess being formed in the outer surface of the body; and
at least one through hole being defined through the body.

2. The light device as claimed in claim 1, wherein
the body is a hexagonal body and has
a bottom; and
two ends;
the recess is formed in the bottom of the hexagonal body;
each through hole is define through the hexagonal body from one end to the other end.

3. The light device as claimed in claim 1, wherein each through hole has
an inner chamber;
an inner wall; and
at least one fin being thermal conductive, being mounted in the inner chamber of the through hole and connecting to the inner wall to separate the inner chamber into multiple cubicles.

4. The light device as claimed in claim 2, wherein each through hole has
an inner chamber;
an inner wall; and
at least one fin being thermal conductive, being mounted in the inner chamber of the through hole and connecting to the inner wall to separate the inner chamber into multiple cubicles.

5. The light device as claimed in claim 3, wherein each cubicle comprises multiple partitions being mounted in the cubicle in parallel.

6. The light device as claimed in claim 4, wherein each cubicle comprises multiple partitions being mounted in the cubicle in parallel.

7. The light device as claimed in claim 3, wherein each cubicle comprises multiple net partitions being mounted in the cubicle to separate the cubicle into multiple grids.

8. The light device as claimed in claim 4, wherein each cubicle comprises multiple net partitions being mounted in the cubicle to separate the cubicle into multiple grids.

9. The light device as claimed in claim 2, wherein
the hexagonal body further has a top that is reversed-V shaped and the bottom of the hexagonal body is flat.

10. The light device as claimed in claim 1 further having a fastening hole being defined through the body of the light housing.

11. The light device as claimed in claim 2 further having a fastening hole being defined through the hexagonal body from one end to the other end.

12. The light device as claimed in claim 3 further having a fastening hole being defined through the body of the light housing.

13. The light device as claimed in claim 4 further having a fastening hole being defined through the hexagonal body from one end to the other end.

14. The light device as claimed in claim 5 further having a fastening hole being defined through the body of the light housing.

15. The light device as claimed in claim 6 further having a fastening hole being defined through the hexagonal body from one end to the other end.

16. The light device as claimed in claim 7 further having a fastening hole being defined through the body of the light housing.

17. The light device as claimed in claim 8 further having a fastening hole being defined through the hexagonal body from one end to the other end.

18. The light device as claimed in claim 9 further having a fastening hole being defined through the hexagonal body from one end to the other end.
